(19) United States
(12) Patent Application Publication
(10) Pub. No.: US 2026/0364580 A1
(43) Pub. Date: Nov. 19, 2026

(54) SOLID BASE CATALYST FOR BIODIESEL PRODUCTION, AND METHOD FOR MANUFACTURE OF SAME

(71) Applicant: KOREA INSTITUTE OF ENERGY RESEARCH, Daejeon (KR)

(72) Inventors: Hak-joo KIM, Daejeon (KR); Deog-keun KIM, Daejeon (KR); Sung Eun KIM, Daejeon (KR); Ji Hu KIM, Seoul (KR)

(73) Assignee: KOREA INSTITUTE OF ENERGY RESEARCH, Daejeon (KR)

(21) Appl. No.: 19/132,257

(22) PCT Filed: Jan. 19, 2023
(86) PCT No.: PCT/KR2023/000917

§ 371 Date: May 22, 2025

(30) Foreign Application Priority Data
Nov. 23, 2022 (KR) 10-2022-0158014

(51) Int. Cl. B01J 27/24; B01J 37/04; B01J 37/08; C10G 3/00

(52) U.S. Cl. CPC B01J 27/24; B01J 37/04; B01J 37/084; C10G 3/44; C10G 2300/1014; C10G 2400/04

(57) ABSTRACT

The present invention relates to a solid base catalyst for biodiesel production, the catalyst comprising graphitic carbon nitride and basic material doped therein. The catalyst is easily extracted and recovered from the final produced biodiesel and can stay superbly active even with repeated reuse.

### BACKGROUND OF THE INVENTION

### (a) Field of the Invention

The present exemplary embodiments relate to a solid base catalyst for biodiesel production and a method of preparing the same, and more particularly, to a solid base catalyst for biodiesel production containing graphitic carbon nitride and a metal doped with the graphitic carbon nitride, and a method of preparing the same.

### (b) Description of the Related Art

In accordance with an increase in concern about climate change, a demand for renewable energy and carbon-neutral energy has increased, and a stable supply of liquid fuels is required in transportation. Even when renewable energy use is the highest in the Net Zero Emissions by 2050 (NZE) scenario, the market share of electric vehicles (EVs) is expected to be only 60%, and the energy used needs to be supplemented with carbon-neutral energy sources such as hydrogen, ammonia, and biofuels. Meanwhile, among biofuels, biodiesel is expected to become a carbon-neutral liquid fuel that may satisfy surplus energy demand.

Biodiesel is defined as a methyl or ethyl ester compound of a fatty acid produced from vegetable oil or animal fat. Biodiesel is suitable as an eco-friendly automobile fuel because it may significantly reduce emissions of air pollutants such as carbon monoxide, fine dust, hydrocarbons, and toxic substances compared to conventional diesel fuel. Biodiesel may be obtained by transesterification of triglycerides (TGs) with alcohol in the presence of a base catalyst. In general, homogeneous base catalysts such as sodium hydroxide and potassium hydroxide are used as base catalysts, but these base catalysts have the problem of being difficult to extract and recover from a final product. In order to solve the above problems, a heterogeneous base catalyst doped with an alkali metal or an alkaline earth metal has been proposed as an alternative, but there is a problem that the biodiesel conversion efficiency decreases as the number of recycles of the extracted and recovered heterogeneous base catalyst increases.

Therefore, there is a need for technology development for a catalyst for biodiesel production that is easy to extract and recover from a final product and has an excellent retention of biodiesel conversion efficiency when recycled.

### SUMMARY OF THE INVENTION

### Technical Problem

The present disclosure has been made in an effort to provide a solid base catalyst for biodiesel production having advantages of being easy to extract and recover from biodiesel to be finally produced and maintaining excellent activity even when repeatedly recycled, and a method of preparing the same.

### Technical Solution

An exemplary embodiment of the present disclosure provides a solid base catalyst for biodiesel production, the solid base catalyst containing: graphitic carbon nitride; and a basic material doped in the graphitic carbon nitride.

The basic material may include one or more selected from alkali metals or alkaline earth metals, and a content of the basic material may be in a range of 1 wt % to 20 wt %.

The solid base catalyst may have an average crystal size in a (100) plane in a range of 1 nm to 15 nm in an X-ray diffraction measurement.

In addition, the graphitic carbon nitride may form a graphitic carbon nitride laminate by stacking two or more single layers, the basic material may be doped on a surface of the graphitic carbon nitride laminate, and the graphitic carbon nitride may have a distance between the single layers of 0.30 nm or more and less than 0.35 nm.

Another exemplary embodiment of the present disclosure provides a method of preparing a solid base catalyst for biodiesel production, the method including: obtaining graphitic carbon nitride using a basic organic compound containing an amine group; and mixing the graphitic carbon nitride and a basic compound and reacting the graphitic carbon nitride and the basic compound at a high temperature to obtain a solid base catalyst.

In the mixing of the graphitic carbon nitride and the basic compound and reacting the graphitic carbon nitride and the basic compound at the high temperature to obtain the solid base catalyst, the graphitic carbon nitride and the basic compound may be mixed at a ratio of 1:0.05 to 1:0.5 on a mass basis.

The obtaining of the graphitic carbon nitride using the basic organic compound containing the amine group may include: heating the basic organic compound containing the amine group in a temperature range of 500 °C to 600 °C to obtain a solid material, and pulverizing the obtained solid material to obtain graphitic carbon nitride powder.

The basic organic compound containing the amine group may include one or more selected from melamine, melam, melem, melon, urea, and thiourea.

In the mixing of the graphitic carbon nitride and the basic compound and reacting the graphitic carbon nitride and the basic compound at the high temperature to obtain the solid base catalyst, the graphitic carbon nitride and the basic compound may be mixed and heated in a temperature range of 500 °C to 600 °C to obtain a solid base catalyst.

In the mixing of the graphitic carbon nitride and the basic compound and reacting the graphitic carbon nitride and the basic compound at the high temperature to obtain the solid base catalyst, the basic compound may be a basic compound containing one or more selected from alkali metals or alkaline earth metals.

In the obtaining of the graphitic carbon nitride using the basic organic compound containing the amine group, the basic organic compound containing the amine group may be mixed, ball milled, and then reacted at a high temperature.

### Advantageous Effects

The solid base catalyst for biodiesel production according to an exemplary embodiment has the advantage of maintaining excellent activity even when repeatedly recycled.

### BRIEF DESCRIPTION OF THE DRAWINGS

FIG. 1 illustrates a process schematic diagram for preparing a solid base catalyst according to an exemplary embodiment.

FIG. 2 illustrates a conceptual diagram of a solid base catalyst according to an exemplary embodiment.

FIGS. 3A and 3B illustrate TEM images of a solid base catalyst according to Example 1.

FIG. 4 illustrates XRD analysis results of final products according to Examples 1 and 2, Preparation Example 1, and Comparative Example 1.

FIG. 5 illustrates FAME conversions when the final products according to Examples 1 and 2, Preparation Example 1, and Comparative Example 1 are first applied.

FIG. 6 illustrates FAME conversions according to recycle recovery of the solid base catalysts according to Example 2 and Comparative Example 1.

### DETAILED DESCRIPTION OF THE EMBODIMENTS

Terminologies used herein are to mention only a specific exemplary embodiment, and are not to limit the present disclosure. Singular forms used herein include plural forms as long as phrases do not clearly indicate an opposite meaning. The term “comprising” used in the specification concretely indicates specific properties, regions, integers, steps, operations, elements, and/or components, and is not to exclude the presence or addition of other specific properties, regions, integers, steps, operations, elements, and/or components.

Unless defined otherwise, all terms including technical terms and scientific terms used herein have the same meanings as understood by those skilled in the art to which the present disclosure pertains. Terms defined in a generally used dictionary are additionally interpreted as having the meanings matched to the related technical document and the currently disclosed contents, and are not interpreted as ideal or very formal meanings unless otherwise defined.

In addition, unless otherwise specified, % means wt %, and 1 ppm is 0.0001 wt %.

The terms “first”, “second”, “third”, and the like are used to describe various parts, components, regions, layers, and/or sections, but are not limited thereto. These terms are only used to differentiate a specific part, component, region, layer, or section from another part, component, region, layer, or section. Accordingly, a first component, part, region, layer, or section which will be described hereinafter may be referred to as a second component, part, region, layer, or section without departing from the scope of the present disclosure.

Hereinafter, exemplary embodiments of the present disclosure will be described in detail. However, these exemplary embodiments are provided as examples, the present disclosure is not limited thereto, and the present disclosure is defined by the scope of claims.

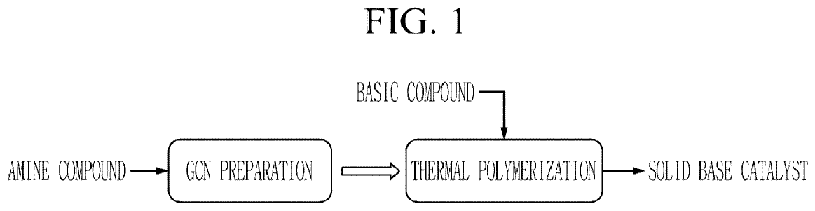

FIG. 1 illustrates a process schematic diagram for preparing a solid base catalyst according to an exemplary embodiment.

Referring to FIG. 1, a process of preparing a solid base catalyst according to an exemplary embodiment includes: preparing graphitic carbon nitride (GCN) using an amine compound; and mixing the graphitic carbon nitride (GCN) and a basic compound and performing a thermal polymerization reaction.

In an exemplary embodiment, the amine compound may be a basic organic compound containing an amine group, and specifically, may include one or more selected from melamine, melam, melem, melon, urea, and thiourea.

In the preparing of the graphitic carbon nitride (GCN) using the amine compound, the amine compound is heated to a temperature of 500 °C to 600 °C at a heating rate of 10 °C/min, and then, a thermal polymerization reaction is performed for 3 hours to 5 hours under conditions where the temperature is maintained to produce a solid material. The produced solid material is pulverized and separated to obtain GCN powder having an average particle size (D50) in a range of 300 μm to 400 μm.

In the mixing of the graphitic carbon nitride (GCN) and the basic compound and performing the thermal polymerization reaction, the obtained GCN powder having the average particle size (D50) in the range of 300 μm to 400 μm and the basic compound may be mixed at a ratio of 1:0.01 to 1:1 on a mass basis, specifically, at a ratio of 1:0.05 to 1:0.5 on a mass basis, and more specifically, at a ratio of 1:0.1 to 1:0.3 on a mass basis, thereby performing a thermal polymerization reaction. When the mixing ratio of the GCN powder and the basic compound is within the above range, a structure of the GCN powder may be maintained, a crystal particle size of the solid base catalyst may be appropriately controlled, and it is advantageous in maintaining excellent biodiesel conversion efficiency when the prepared solid base catalyst is repeatedly used.

The basic compound may be a basic compound containing one or more selected from alkali metals or alkaline earth metals. Specifically, the basic compound may be a basic compound containing one or more selected from lithium (Li), sodium (Na), potassium (K), rubidium (Rb), cesium (Cs), francium (Fr), beryllium (Be), magnesium (Mg), calcium (Ca), strontium (Sr), barium (Ba), and radium (Ra). More specifically, the basic compound may include one or more selected from lithium hydroxide (LiOH), sodium hydroxide (NaOH), potassium hydroxide (KOH), rubidium hydroxide (RbOH), cesium hydroxide (CsOH), francium hydroxide (FrOH), beryllium hydroxide (Be(OH)₂), magnesium hydroxide (Mg(OH)₂), calcium hydroxide (Ca(OH)₂), strontium hydroxide (Sr(OH)₂), barium hydroxide (Ba(OH)₂), and radium hydroxide (Ra(OH)₂).

The graphitic carbon nitride (GCN) and the basic compound may be mixed, the temperature may be increased to 500 °C to 600 °C at a heating rate of 10 °C/min, and then, a thermal polymerization reaction may be performed for 3 hours to 5 hours under conditions in which the temperature is maintained at 500 °C to 600 °C. When the thermal polymerization reaction temperature is within the above range, a surface area of the solid base catalyst may be appropriately maintained, and it is advantageous in minimizing energy consumption in the solid base catalyst preparation process while maintaining excellent performance when the prepared solid base catalyst is repeatedly recycled.

The solid base catalyst obtained by mixing the graphitic carbon nitride (GCN) and the basic compound and performing a thermal polymerization reaction may be pulverized and then separated to obtain a final solid base catalyst having an average particle size (D50) in a range of 100 μm to 1,000 μm, and specifically, in a range of 300 μm to 500 μm. When the average particle size of the solid base catalyst is within the above range, it is advantageous to extract and recover the solid base catalyst from a finally produced biodiesel and to use it repeatedly while maintaining excellent efficiency.

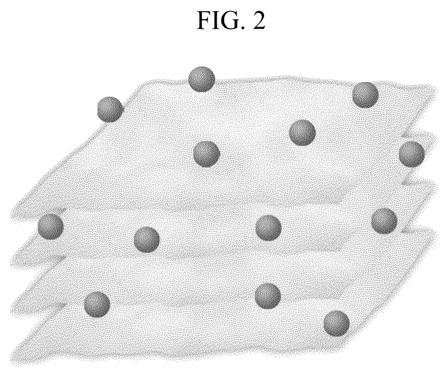

FIG. 2 illustrates a conceptual diagram of a solid base catalyst according to an exemplary embodiment.

Referring to FIG. 2, the solid base catalyst according to an exemplary embodiment of the present disclosure may contain graphitic carbon nitride (GCN); and a basic material (M) doped in the graphitic carbon nitride.

The basic compound may be a basic compound containing one or more selected from alkali metals or alkaline earth metals. Specifically, the basic compound may be a basic compound containing one or more selected from lithium (Li), sodium (Na), potassium (K), rubidium (Rb), cesium (Cs), francium (Fr), beryllium (Be), magnesium (Mg), calcium (Ca), strontium (Sr), barium (Ba), and radium (Ra). The basic material may be contained in an amount ranging from 1 wt % to 20 wt % on a mass basis, and specifically, may be contained in an amount ranging from 3 wt % to 15 wt % on a mass basis. When the content of the basic material is within the above range, it is advantageous to extract and recover a solid base catalyst from biodiesel and use the solid base catalyst repeatedly while maintaining excellent efficiency.

The basic material may be uniformly dispersed on a surface of the graphitic carbon nitride. Specifically, the basic material may be uniformly dispersed on surfaces of a plurality of graphitic carbon nitride layers formed by stacking two or more layers. In X-ray diffraction (XRD) analysis, a laminate vertical cross-section (zy plane) formed by stacking graphitic carbon nitride corresponds to a (002) plane. A (100) plane reflects a tri-s-triazine hole structure present in the structure, which may be used to determine whether the GCN structure is maintained.

A distance between adjacent graphitic carbon nitride layers of the plurality of graphitic carbon nitride layers may be 0.30 nm or more and less than 0.35 nm, specifically, may be 0.31 nm to 0.33 nm, and more specifically, may be 0.32 nm. The interlayer distance is calculated using the following Bragg's equation (1):

nλ=2d sin θ (1)
(where λ is an X-ray wavelength, d is an interlayer distance, n is an integer, and θ is an X-ray incident angle).

In addition, an average crystal size of a (100) plane (2θ=27.4±0.5) of the solid base catalyst in X-ray diffraction (XRD) analysis may be in a range of 1 nm to 15 nm, and specifically, in a range of 2 nm to 10 nm. The average crystal size is calculated using the following Scherrer equation (2):

τ=(Kλ)/(β cos θ) (2)
(where K is a shape factor (dimensionless number), which is approximately 0.9 but varies depending on an actual shape of a crystal, λ is an X-ray wavelength, p is a half width of FWHM of the maximum intensity peak (unit: radians), and 6 is an X-ray incident angle).

### DETAILED DESCRIPTION OF THE EMBODIMENTS

Hereinafter, preferred preparation examples, examples, and comparative examples of the present disclosure will be described. However, each of the following examples is merely a preferred example of the present disclosure, and the present disclosure is not limited to the following examples.

### Preparation Example 1

Melamine (Sigma Aldrich) was charged into a crucible with a cover, heated to 550 °C at a heating rate of 10 °C/min, and maintained at 550 °C for 4 hours to obtain a light yellow solid material. The obtained light yellow solid material was pulverized and sieved to prepare GCN powder having an average particle size (D50) in a range of 300 μm to 400 μm.

### Comparative Example 1

The GCN powder prepared in Preparation Example 1 was mixed with NaOH at a ratio of 1:0.25 on a mass basis and then ultrasonicated at room temperature for 1 hour. The sonicated product was heated at 550 °C for 2 hours while supplying N₂ gas in a rotary evaporator to prepare Na-impregnated GCN.

### Example 1

The GCN powder prepared in Preparation Example 1 and NaOH were mixed at a ratio of 1:0.1 on a mass basis, charged into a crucible with a cover, heated to 550 °C at a heating rate of 10 °C/min, and then maintained at 550 °C for 4 hours to obtain a solid material. The obtained solid material was pulverized and sieved to prepare a solid base catalyst having an average particle size (D50) in a range of 300 μm to 400 μm.

### Example 2

A solid base catalyst was prepared in the same manner as in Example 1, except that GCN powder and NaOH were mixed at a ratio of 1:0.25 on a mass basis.

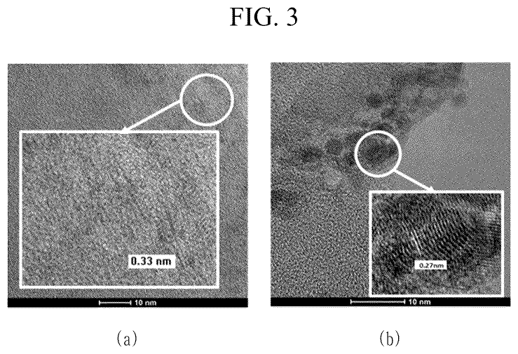

FIGS. 3A and 3B illustrate TEM images of the solid base catalyst according to Example 1.

Specifically, FIG. 3A illustrates a TEM analysis image of the solid base catalyst according to Preparation Example 1, and FIG. 3B illustrates a TEM analysis image of the solid base catalyst according to Example 2. Referring to FIGS. 3A and 3B, it was confirmed that the solid base catalyst according to Example 2 was present in the form of Na particles dispersed on the GCN surface.

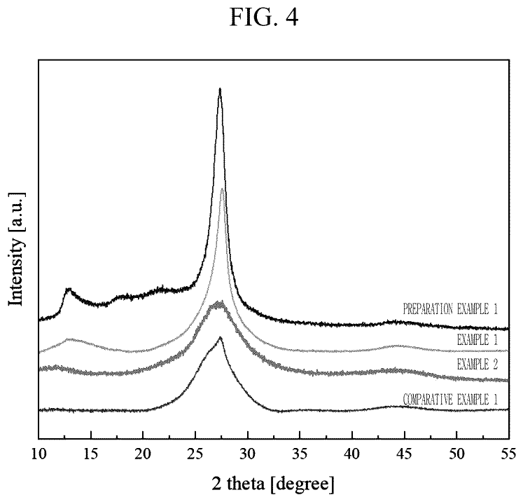

FIG. 4 illustrates XRD analysis results of final products according to Examples 1 and 2, Preparation Example 1, and Comparative Example 1.

Referring to FIG. 4, in the X-ray diffraction (XRD) analysis results, a peak corresponding to a (100) plane was confirmed at 2θ=13.3±0.5, and a peak corresponding to a (002) plane was confirmed at 2θ=27.4±0.5. A (100) peak of the solid base catalyst, which is the final product according to each of Examples 1 and 2, was confirmed at a lower angle compared to Preparation Example 1, and it was confirmed that the (100) peak shifted at a much lower angle as a content of Na increased. In addition, it was confirmed that as the content of Na increased, a width of the (100) peak widened.

Meanwhile, in the XRD analysis of the final product prepared according to Comparative Example 1, no (100) peak was observed, which means that the tri-s-triazine structure including the GCN plane in Comparative Example 1 was completely opened. In addition, in addition to a (002) peak, a new peak was confirmed at 2θ=25.2, which is considered to be due to the insertion of Na between the GCN layers. On the other hand, the GCN interlayer distance of each of the final products prepared according to Preparation Example 1 and Examples 1 to 2 was calculated to be 0.32 nm, and the GCN interlayer distance of the final product prepared according to Comparative Example 1 was confirmed to be 0.35 nm.

In addition, the crystal sizes calculated on the (100) planes of the final products prepared according to Preparation Example 1 and Examples 1 and 2 were calculated as 27.9 nm, 9.1 nm, and 3.2 nm, respectively.

### (Biodiesel Production)

Biodiesel production experiments were conducted by applying the final products prepared according to Preparation Example 1, Comparative Example 1, and Examples 1 and 2 as catalysts for biodiesel production.

Specifically, the biodiesel production experiments were conducted as follows.

29.1 g of soybean oil, 71.3 g of methanol, and 11 wt % of a catalyst were put into a flask, stirred at a stirring speed of 375 rpm, heated to 70 °C, and reacted for 4 hours. After the reaction was completed, a liquid product from which a solid material was separated was diluted with methanol.

Meanwhile, the catalyst was separated, washed with hexane (100 ml/g), dried at 60 °C, and then recycled.

The amount of produced fatty acid methyl ester (FAME), that is, biodiesel, was analyzed using gas chromatography (GC, Agilent 6890, Agilent). At this time, INNOWax capillary column (30 m×0.32 mm×0.5 μm, Agilent) and a flame ionization detector (FID) were used. A sample injector was set to 250 °C, an injection amount of 1 μl, and a split ratio of 80:1. An oven was maintained at 210 °C for 9 minutes, heated to 230 °C at a heating rate of 20 °C/min, and then maintained for 10 minutes.

FAME conversion was calculated by the following equation.

$$Conversion [ \% ] = \frac{{FAME}_{product [ g ]}}{Soybean {oil}_{in [ g ]}} \qquad ( 3 )$$

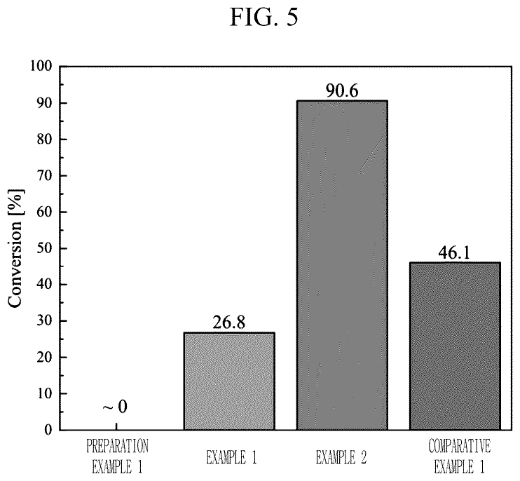

FIG. 5 illustrates FAME conversions when the final products according to Examples 1 and 2, Preparation Example 1, and Comparative Example 1 are first applied.

Referring to FIG. 5, when the solid base catalysts according to Examples 1 and 2 were applied, the FAME conversions were 26.8% and 90.6%, respectively, and when the solid base catalyst according to Comparative Example 1 was applied, the FAME conversion was 46.1%.

On the other hand, when GCN according to Preparation Example 1 was applied, it was confirmed that soybean oil and methanol did not undergo a biodiesel conversion reaction.

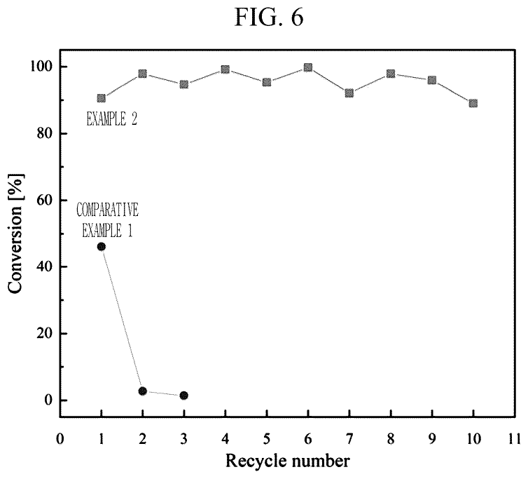

FIG. 6 illustrates FAME conversions according to recycle recovery of the solid base catalysts according to Example 2 and Comparative Example 1.

Referring to FIG. 6, when the solid base catalyst according to Example 2 was separated after producing biodiesel, washed with hexane (100 ml/g), dried at 60 °C, and then repeatedly recycled 10 times, it was confirmed that the biodiesel conversion was maintained at 90% or more. On the other hand, in the case of the solid base catalyst according to Comparative Example 1, the biodiesel conversion was 46.1% when first applied to the biodiesel production process, but when recycled, the biodiesel conversion was found to decrease to about 1%.

The present disclosure is not limited to the exemplary embodiments, but may be prepared in various different forms, and it will be apparent to those skilled in the art to which the present disclosure pertains that the exemplary embodiments may be implemented in other specific forms without departing from the spirit or essential feature of the present disclosure. Therefore, it is to be understood that the exemplary embodiments described hereinabove are illustrative rather than restrictive in all aspects.

1. A solid base catalyst for biodiesel production, the solid base catalyst comprising:
graphitic carbon nitride; and
a basic material doped in the graphitic carbon nitride.

2. The solid base catalyst of claim 1, wherein:
the basic material includes one or more selected from alkali metals or alkaline earth metals.

3. The solid base catalyst of claim 1, wherein:
a content of the basic material is 1 wt % to 20 wt %.

4. The solid base catalyst of claim 1, wherein:
the solid base catalyst has an average crystal size in a (100) plane in a range of 1 nm to 15 nm in an X-ray diffraction measurement.

5. The solid base catalyst of claim 1, wherein:
the graphitic carbon nitride forms a graphitic carbon nitride laminate by stacking two or more single layers.

6. The solid base catalyst of claim 5, wherein:
the basic material is doped on a surface of the graphitic carbon nitride laminate.

7. The solid base catalyst of claim 5, wherein:
the graphitic carbon nitride has a distance between the single layers of 0.30 nm or more and less than 0.35 nm.

8. A method of preparing a solid base catalyst for biodiesel production, the method comprising:
obtaining graphitic carbon nitride using a basic organic compound containing an amine group; and
mixing the graphitic carbon nitride and a basic compound and reacting the graphitic carbon nitride and the basic compound at a high temperature to obtain a solid base catalyst.

9. The method of claim 8, wherein:
in the mixing of the graphitic carbon nitride and the basic compound and reacting the graphitic carbon nitride and the basic compound at the high temperature to obtain the solid base catalyst,
the graphitic carbon nitride and the basic compound are mixed at a ratio of 1:0.05 to 1:0.5 on a mass basis.

10. The method of claim 8, wherein:
the obtaining of the graphitic carbon nitride using the basic organic compound containing the amine group includes:
heating the basic organic compound containing the amine group in a temperature range of 500 °C to 600 °C to obtain a solid material; and
pulverizing the obtained solid material to obtain graphitic carbon nitride powder.

11. The method of claim 8, wherein:
the basic organic compound containing the amine group includes one or more selected from melamine, melam, melem, melon, urea, and thiourea.

12. The method of claim 10, wherein:
in the mixing of the graphitic carbon nitride and the basic compound and reacting the graphitic carbon nitride and the basic compound at the high temperature to obtain the solid base catalyst,
the graphitic carbon nitride and the basic compound are mixed and heated in a temperature range of 500 °C to 600 °C to obtain a solid base catalyst.

13. The method of claim 8, wherein:
in the mixing of the graphitic carbon nitride and the basic compound and reacting the graphitic carbon nitride and the basic compound at the high temperature to obtain the solid base catalyst,
the basic compound is a basic compound containing one or more selected from alkali metals or alkaline earth metals.

14. The method of claim 8, wherein:
in the obtaining of the graphitic carbon nitride using the basic organic compound containing the amine group,
the basic organic compound containing the amine group is mixed, ball milled, and then reacted at a high temperature.
